(19) United States
(12) Patent Application Publication
(10) Pub. No.: US 2016/0207062 A1
(43) Pub. Date: Jul. 21, 2016

(54) AIRBRUSH CLEANER

(71) Applicant: George Lampman, Van Nuys, CA (US)

(72) Inventor: George Lampman, Van Nuys, CA (US)

(21) Appl. No.: 14/996,659

(22) Filed: Jan. 15, 2016

Related U.S. Application Data
(60) Provisional application No. 62/104,040, filed on Jan. 15, 2015.

(51) Int. Cl. B05B 15/02; B05B 7/06

(52) U.S. Cl. CPC B05B 15/025; B05B 7/064

(57) ABSTRACT

An airbrush cleaning system is disclosed which includes a nose cap configured to sealingly fit on a spray nose assembly of an airbrush, a reservoir cap configured to sealingly fit over a liquid reservoir of the airbrush, a first tether connecting the bulb nose cap and the reservoir cap, a cap plug configured to seal off an air inlet port of the airbrush, a lever block configured to hold an airbrush needle valve in the open position, and a second tether connecting the cap plug and the lever block. A kit including the cleaning system and the airbrush and a method for using the cleaning system are also disclosed.

### FIELD

The present invention relates to a system to clean an airbrush of dried and caked on spray liquid residue, such as make-up, paint, etc. The system also inhibits the formation of dried residue by sealing the liquid reservoir cup and spray nose assembly

### BACKGROUND

An airbrush operates by passing a stream of compressed air or gas through a Venturi tube, which generates a localized zone of reduced pressure or suction. This suction is used to draw liquid containing pigment (solution), such as make-up, paint, etc., from a reservoir. The velocity of the compressed air stream atomizes the liquid pigment into a stream of tiny droplets as it is drawn past the metering nozzle. The airbrush includes an airbrush nozzle and needle assembly, which has two primary functions. The first is to serve as a valve to meter the liquid as it is expelled from the airbrush. The needle tip, by way of the needle shaft is linked with the lever. The needle tip, as it is pulled back (as a valve) by the lever (as a handle), functions to regulate the amount of liquid entering the airstream. The second function of the airbrush nozzle and needle assembly is to provide aerodynamics, in that for purposes of atomization, it introduces the liquid in the accelerated air stream (based on the specifics of its shape) and it acts as a liquid pump by creating a vacuum effect at the nozzle tip that draws (negative pressure) the liquid from the reservoir into the airstream.

When the airbrush is not in use for a period of time, the liquid pigment will dry, depositing pigment residue in and on the nozzle and inside the liquid passageway rendering the airbrush inoperative. The traditional method of soaking the airbrush in cleaning solution does not always completely remove all residues. Additionally, it involves taking apart the airbrush to have access to all of the parts that need to be cleaned. This can result in damage to the airbrush components, so that they no longer work. One example of such an airbrush used for makeup application is in U.S. Pat. No. 7,389,948, the entirety of which is incorporated by reference herein.

Cleaning the interior channel effectively is the most time consuming aspect of traditional airbrush cleaning. Most damage to airbrushes or loss of parts occurs during traditional cleaning activities that includes various degrees of airbrush disassembly. Cleaning without disassembly is safer for the airbrush, more time efficient, reliable and conserves cleanser.

During regular use, it is typical for some makeup to dry on the wall of the reservoir cup or thicken over time in the open air of the reservoir cup. Over an extended period of continuous use that makeup, if allowed to remain, can become loose and flow into the liquid channel and create reductions in liquid flow or obstructions. Simple flushing of the airbrush using water or cleaner after use is insufficient to prevent or remove the typical and progressive buildup of resin and pigment materials in the interior channel and nozzle.

Pigments alone would be quite easy to purge. However, the liquid base material has properties to encapsulate pigment particles and therefore, solidify like glue on the skin and even better on the airbrush parts. Therefore, there is a need to provide a method and system for cleaning the airbrush parts without the necessity for taking apart the airbrush.

The inventive system provides for long term presence of the cleaning solution (in direct contact with resin materials), which has the effect of gradually solubilizing the resins, film forming materials that envelop and adhere the pigments. The film forming base materials are design to dry, set and adhere pigments to surfaces. The sustained presence of cleaning solution functions like pre-soaking a stain or dishes.

In view of the foregoing, there is also a need in the art for apparatuses and systems enabling the agitation of a cleaning solution at the airbrush spray nose assembly of the airbrush and within the liquid passageway up to and including the liquid reservoir cup to facilitate the complete removal of dried and caked on pigment, restoring the airbrush to its proper operating condition.

Also in view of the foregoing, a convenient and portable device that would prolong the drying time of the pigments is needed. This easy to use device will allow the end user more time to properly and easily clean the airbrush.

### SUMMARY

An airbrush cleaning system according to one embodiment includes a nose cap configured to sealingly fit on a spray nose assembly of an airbrush, a reservoir cap configured to sealingly fit over a liquid reservoir of the airbrush, a first tether connecting the nose cap and the reservoir cap, a cap plug configured to seal off an air inlet port of the airbrush, a lever block configured to hold an airbrush needle in the open position, and a second tether connecting the cap plug and the lever block.

In the airbrush cleaning system according to one embodiment, the nose cap, the reservoir cap and the first tether form a unitary, one piece component set, and the cap plug, the lever block and the second tether form a unitary, one piece component set.

According to one embodiment, the nose cap, the reservoir cap, the first tether, the cap plug, the lever block, and the second tether are made of a pliable, elastic material. The pliable elastic material may be a medical grade silicone.

According to one embodiment, the nose cap includes an outer surface, an opening and an interior fluid storage region that fits circumferentially and seals onto the spray nose assembly of the airbrush to make an air tight seal. The outer surface of the nose cap is deformable such that when compressed and released causes any liquid inside the liquid reservoir to transfer between the fluid storage region through a liquid passageway in the spray nose assembly and the liquid reservoir and back again.

According to one embodiment, the reservoir cap includes an annular ring and a bellows portion covering the annular ring.

According to one embodiment, a kit includes an airbrush for applying a liquid to a surface, and cleaning components. The airbrush includes a spray nose assembly through which the liquid is sprayed, a handle comprising an air inlet port; a reservoir into which the liquid is placed; a needle disposed in the spray nose assembly for controlling flow of the liquid; and an internal passageway between the spray nose assembly and the reservoir. The cleaning components include a first component set comprising a nose cap configured to fit on the spray nose assembly, and a reservoir cap connected to the nose cap and configured to fit on the reservoir; and a second component set comprising a cap plug configured to seal off the air inlet port of the airbrush, and a lever block connected to the cap plug and configured to hold the needle in the open position.

According to one embodiment of the kit, a first tether connects the nose cap and the reservoir cap, and a second tether connects the cap plug and the lever block, and the first tether and the second tether provide tension between the nose cap and the reservoir cap, and between the cap plug and the lever block, respectively, to keep the first and second component sets in a desired sealed position when in use and during transportation.

According to one embodiment, a method of cleaning the airbrush includes placing a nose cap on a spray nose of the airbrush, placing a cap plug over an air inlet port in a handle of the airbrush, placing a lever block in position between an airbrush lever and the liquid reservoir, squeezing an amount of cleaning solution into a liquid reservoir, repeatedly squeezing the nose cap to flush the cleaning solution into an internal passageway of the airbrush from the liquid reservoir and back again, and placing a reservoir cap over the liquid reservoir;

### BRIEF DESCRIPTION OF THE DRAWINGS

For better understanding of the invention and additional objects and advantages thereof, reference is made to the following detailed description and accompanying drawing of a preferred embodiment, wherein

FIG. 1 is an illustrative perspective view of the airbrush cleaning system in place on an airbrush according to one embodiment.

FIG. 2 is a cut-away view of the airbrush cleaning system in place on an airbrush according to one embodiment.

FIG. 3 is an illustrative view of cleaning liquid being added into the liquid reservoir cup according to one embodiment.

FIG. 4 is an illustrative view of the cleaning liquid in the bulb's open chamber according to one embodiment.

FIG. 5A is an illustrative view of the user squeezing, compressing the bulb containing cleaning solution flushing the solution through the liquid passageway of the airbrush according to one embodiment.

FIG. 5B is a close-up illustrative view of the user squeezing the bulb according to one embodiment.

FIGS. 6A-6D are illustrative views of the airbrush lever block and airway inlet plug joined together with an integrally molded tether according to one embodiment.

FIGS. 7A and 7B are illustrative views depicting the numbered sequence for placing the elastic cap, elastic bulb cap, elastic plug cap, and lever block on the airbrush according to one embodiment.

FIGS. 8A-8D are illustrative views of the bulb and cap joined together with an integrally molded tether according to one embodiment.

FIG. 9 is a flowchart showing a method of using the cleaning system according to one embodiment.

### DETAILED DESCRIPTION

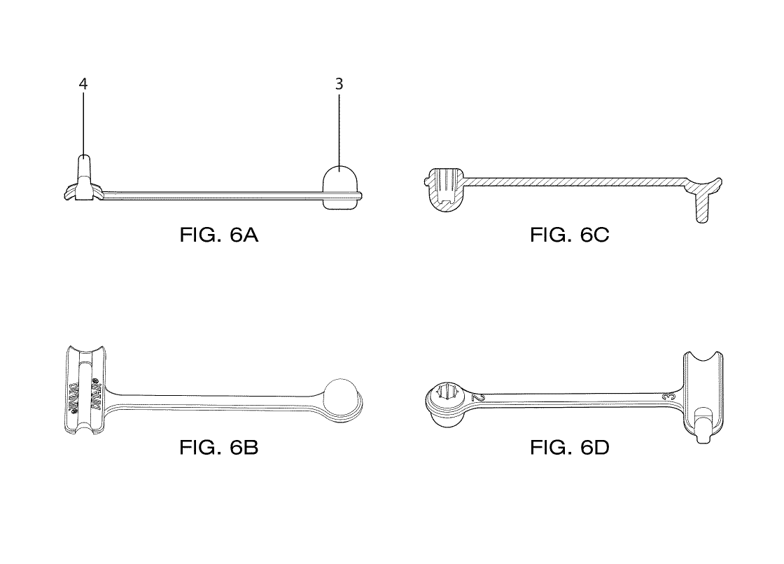

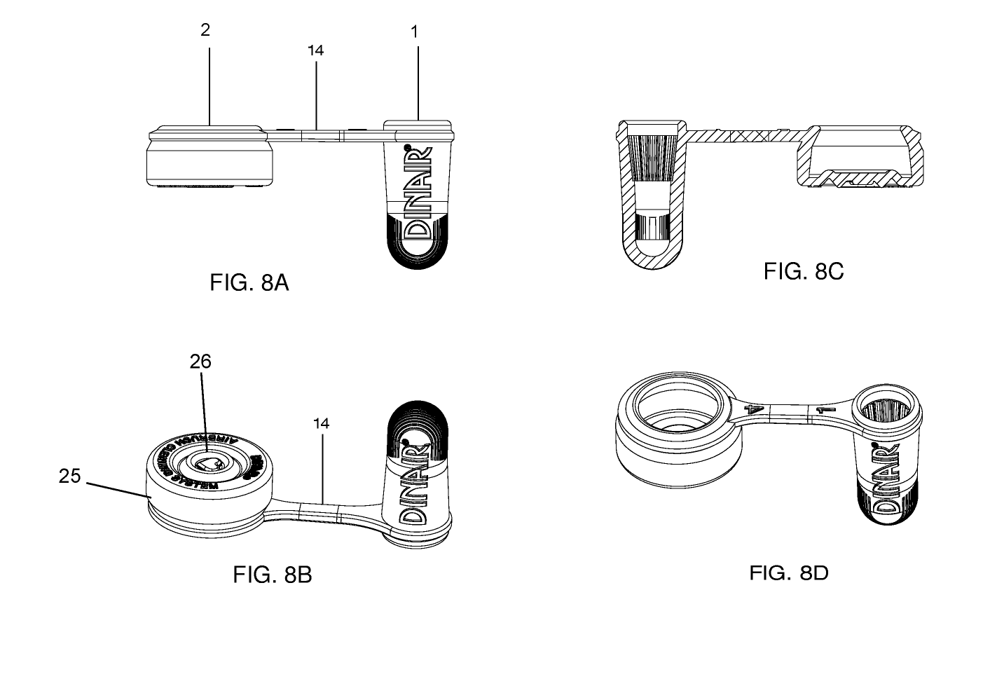

A system for residue removal, cleaning and transport of airbrushes, a kit, and a method for cleaning an airbrush are provided. The system is comprised of a plurality of four components tethered together in sets of two. A series of four numbers are integrally molded adjacent to each component (see FIGS. 6A-6D and 8A-8D), and instruct the user to the proper application sequence of the four components onto an airbrush. The kit includes the airbrush and the cleaning components.

One component of the airbrush cleaning system is a nose cap having an outer surface, an opening and an interior fluid storage region therein that fits circumferentially and seals positively onto the spray nose assembly of an airbrush to make an air tight seal. This system further comprises a volume of cleaning fluid within the nose cap's interior fluid storage region that, when the nose cap is compressed and released, flushes an airbrush cleaning solution back and forth through the airbrush's internal passageway and into the liquid reservoir cup. The cleaning action dissolves and flushes makeup and other pigment residue deposits into the nose cap's interior fluid storage region.

Another component of the airbrush cleaning system is a reservoir cap that fits circumferentially and seals positively onto the top rim of the liquid reservoir cup to contain spillage of any cleaning solution from the liquid reservoir cup when, for example, the airbrush is transported or placed in any position. The reservoir cap has an annular ring covered by a top surface. The top surface is preferably formed in a bellows configuration that is sufficiently flexible to allow for the expansion and contraction of air pressure within the reservoir cup when the nose cap is compressed and released.

A tether is provided between the nose cap and reservoir cap and provides tension between the two components to keep in the desired sealed position when in use and during transportation.

The nose cap is made from a material that, when compressed and released, causes any liquid inside the fluid storage region to transfer into the liquid passageways and into the liquid reservoir cup of the airbrush. To accomplish this, the nose cap may be made from a pliable elastomeric material, such as medical grade silicone or the like. The reservoir cap is preferably made from a pliable elastomeric material, such as medical grade silicone or the like. The tether is also preferably made of a pliable elastomeric material, such as medical grade silicone or the like. Preferably, the liquid is a cleaning solution appropriate for dissolving, liquefying and removing specific material residues used in the operation of the airbrush.

The nose cap, when removed from an airbrush, can be used to transport the soiled cleaning solution contained within a fluid storage region to a safe disposal site.

The nose cap may also be utilized by the user to seal the airbrush spray nose assembly and liquid passageways to prevent residual liquid makeup or other pigments from drying during periods between applications and cleanings. The reservoir cap may also be utilized by the user to seal the airbrush liquid reservoir cup and to prevent liquid makeup and other pigments from drying out during periods between applications and cleanings.

Another component of the airbrush cleaning system is an airbrush lever block to retain the airbrush's needle in the fully “open” position to allow liquid cleaning solution to move into and out of the airbrush's liquid passageway freely when the bulb is compressed and released. The airbrush lever block is preferably made of a pliable elastomeric material, such as medical grade silicone or the like.

Another component of the airbrush cleaning system is an airbrush airway inlet cap that fits circumferentially and seals positively onto the rim of the airway inlet surface to contain spillage of any cleaning solution that enters the airway when the bulb is compressed. The airbrush airway inlet cap is preferably made from a pliable elastomeric material, such as medical grade silicone or the like.

To use the cleaning system after the first three components are fitted on the airbrush, cleaning solution is added in the reservoir. The initial pumping of the nose cap provides an active cleaning in the first phase of using the inventive cleaning system. It is usually done with reservoir cap open, though the remaining parts of the cleaning system are installed on the airbrush. The pumping action will result in the development of observable foam or suds in the cup and a rising and falling of the foam corresponding to the pumping action.

The second phase of cleaning using the inventive system is a passive cleaning, wherein there is extended contact with active cleaner. This active contact includes the airbrush liquid channel and additionally, the air channel area immediately adjacent the nozzle tip. That air channel area section may develop an atomized and deposited makeup residue buildup through use and by common user actions in wiping and blotting the nose of the airbrush during use. Thus, makeup buildup may occur in airway on the exterior of the nozzle and the interior of the air regulator orifice that surrounds the nozzle. The orifice accelerates and focuses the exhaust air stream to achieve an atomization effect that mixes the liquid and air.

The full function of the cleaning system is designed to work with the needle tip in the open position. The open needle tip supports the pumping action which introduces cleaning solution to purge loose material, and leave undiluted cleaning solution in the liquid channel. The cleaning system will still clean if the needle is closed, following the pumping action, but at a lower efficiency.

One advantage of the airbrush cleaning system is the new ease of locating undiluted cleanser in the liquid channel without special training.

Another advantage is provided by the option to easily periodically and easily “refresh” of the residual cleaning solution in the liquid channel.

The new system is superior to previous recommendation of storing the airbrush with the cup immersed in liquid to the top of the cup and less messy. Cleaner in the narrow channel around the needle can become saturated or diluted by solubilized pigments and resin, while the main reservoir of cleaner remains at a very active strength.

According to the invention, the accelerated flow of liquid created by the squeezing of the bulb cap has a mechanical washing effect. In the initial cleaning stage, a very slow pumping action will result a rapid flow of liquid through the very narrow liquid channel that surround the needle. The mechanical washing effect of this new rapid flow of liquid will quickly: remove, loosen purge, the materials in the passage and disperse them into the cleaning solution. The active cleaning solution, in direct contact with any residual makeup material, and will over time solubilize congealed or dried material.

The enclosed cap system will prevent (significantly retard) liquid evaporation, eliminating dried makeup events from occurring between uses. Dry makeup that has been solubilized in cleaner cannot harden again as a cohesive film. If the cap was removed without a brief rinse phase, the residue could then dry into power that is very easy to remove.

This system when used properly also significantly retards the drying and caking of makeup and other pigments in the airbrush passageways due the presence of the cleaning fluid and vapor pressure within the system and airbrush.

One advantage of the system according to the disclosed subject matter is that cleaning of the airbrush is much easier, quicker and reliable due the lack of dried or caked on makeup or other pigments in the system.

The disclosed system, when used properly, could eliminate the need for any other type of airbrush internal cleaning.

This system when used properly allows the end user more flexibility for airbrush use between cleanings.

When properly used, the system can function as a complete internal cleaning system and can maintain an airbrush in a rinse and ready to use condition, replacing the need for traditional disassembly and piece by piece cleaning maintenance including, bottle brushes, scrubbing, ultrasonic and other types of active maintenance cleaning procedures. It can also eliminate the need for storing the airbrush with the cup immersed in liquid to the top of the cup, which is less messy.

The present invention relates to a cleaning system for airbrushes used in spraying makeup but may also be used for cleaning airbrushes used for spraying other liquids, for example, materials such as paint, inks, glue, etc. The cleaning system enables the user to clear the fluid passageway of dried make-up and other residue along with other materials noted above and restore or maintain the airbrush normal spraying function. The present invention also significantly retards the drying rate of make-up or other artist materials by inhibition of liquid evaporation from the airbrush. This significantly extends the time for typical airbrush maintenance options.

The nose cap fits over the airbrush spray nose assembly in an airtight manner and retains spillage of any cleaning solution in the liquid reservoir cup when the airbrush is transported or placed in any position by sealing the airbrush. The nose cap also inhibits liquid evaporation from the airbrush, leading to the makeup or other pigments drying in the airbrush. The nose cap when squeezed, forces cleaning solution through the air brush channel into the liquid reservoir cup removing dried or caked on makeup or other pigment residue.

The air inlet cap seals off the air inlet port to prevent any cleaning solution from spilling out of the air inlet when the nose cap is compressed and the solution is forced into liquid reservoir cup and toward the air inlet passageway. The air inlet cap also seals the airbrush for transport or placed in any position.

A lever block is provided to hold and retain the airbrush's lever in an open position, such that the needle is held in the open position, so as not to restrict the movement of cleaning fluid through the spray nose assembly, the liquid passageway and the liquid reservoir cup.

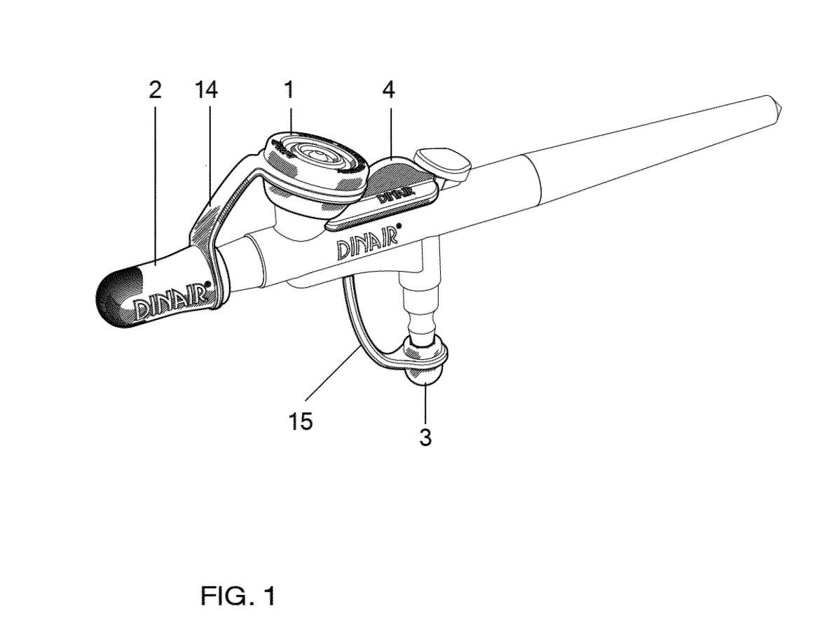

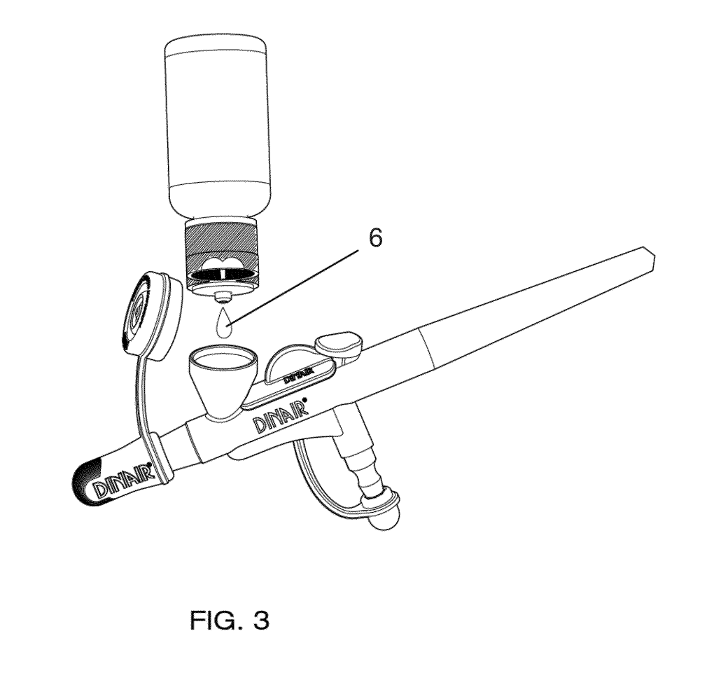

An airbrush cleaning system is described with respect to FIGS. 1-8. The cleaning system is comprised of four pieces with two corresponding pieces preferably joined by a strap tethering the four pieces together in pairs into a component sets. The four pieces and the tethers are preferably made of the same pliable elastomeric material. According to one embodiment, the pliable elastomeric material is medical grade silicone, i.e., a silicone tested for biocompatibility and are appropriate to be used for medical applications. The silicone material is a naturally milky translucent rubber, and it is easy to add color to the material. Other pliable elastomeric materials can also be used. Each component set may include a tether that connects the two pieces, and may be formed in one piece therewith.

As seen in assembled form, one of the component sets includes a nose cap 2 to contain and cycle, by compressing, airbrush cleaning solution 6 into and through the liquid passageway 8, 13 and a reservoir cap 1 to retain from spillage any cleaning solution within the reservoir cup 10 when the airbrush is transported or placed in any position. The nose cap 2 sealingly fits on the spray nose assembly 21 of the airbrush, and the reservoir cap 1 sealingly fits on the reservoir cup 10. The design, thickness and durometer of the nose cap is specific to balance between being squeezable (elastic) to expel liquid into the airbrush, and also have sufficient (elastic) memory and in its molded shape, to force or draw the liquid 6 back from the reservoir cup 10 into the spray nose assembly 21 and the nose cap.

Furthermore, the components shown in FIG. 1 also significantly retard the makeup and other pigment drying process. The tether 14 between the nose cap and reservoir cap also provides tension between the two components which keeps them in place during transportation. The other component set has a cap plug 3 to seal off the air inlet port 26 in the handle 22 to prevent cleaning solution from spilling out and a lever block 4 to hold the airbrush needle in the “open” position so as not to restrict the movement of cleaning fluid 6 in the liquid passageway 8, 13. A tether 15 between the cap plug 3 and the lever block 4 also provides tension between the two components which keeps them in place during transportation.

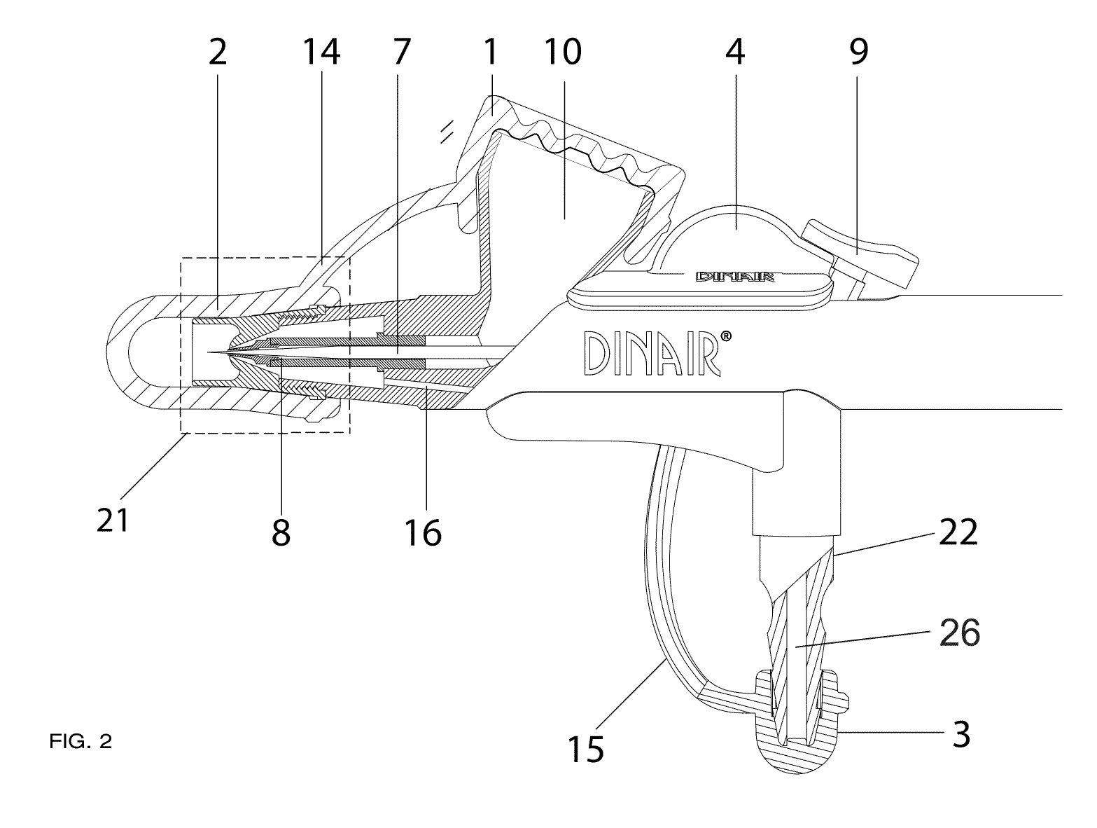

FIG. 2 of the drawings show a cut-away view of the first component set consisting of the nose cap 2 that fits over the spray nose assembly 21 of the airbrush, the reservoir cap 1 that fits over the liquid reservoir cup 10 of the airbrush, and the tether 14 that connects the two together.

FIG. 8A is a side view of the first component set, FIG. 8B is a top perspective view of the first component set, FIG. 8C is a cut-away sectional view of the first component set, and FIG. 8D is a bottom perspective view of the first component set. The reservoir cap 1 has an annular ring 26 and a deformable bellows upper portion 25 (FIG. 8B) that allows for the expansion and contraction of air pressure within the reservoir cup when the nose cap 2 is compressed and released.

FIG. 6A is a side view of the second component set, FIG. 6B is a top perspective view of the second component set, FIG. 6C is a cut-away sectional view of the second component set, and FIG. 6D is a bottom perspective view of the second component set. The size and shape of the various pieces are exemplary only; the sizes and shapes of each of the pieces may be changed within the scope of the invention, as long as they are sized and shaped to operate as described herein.

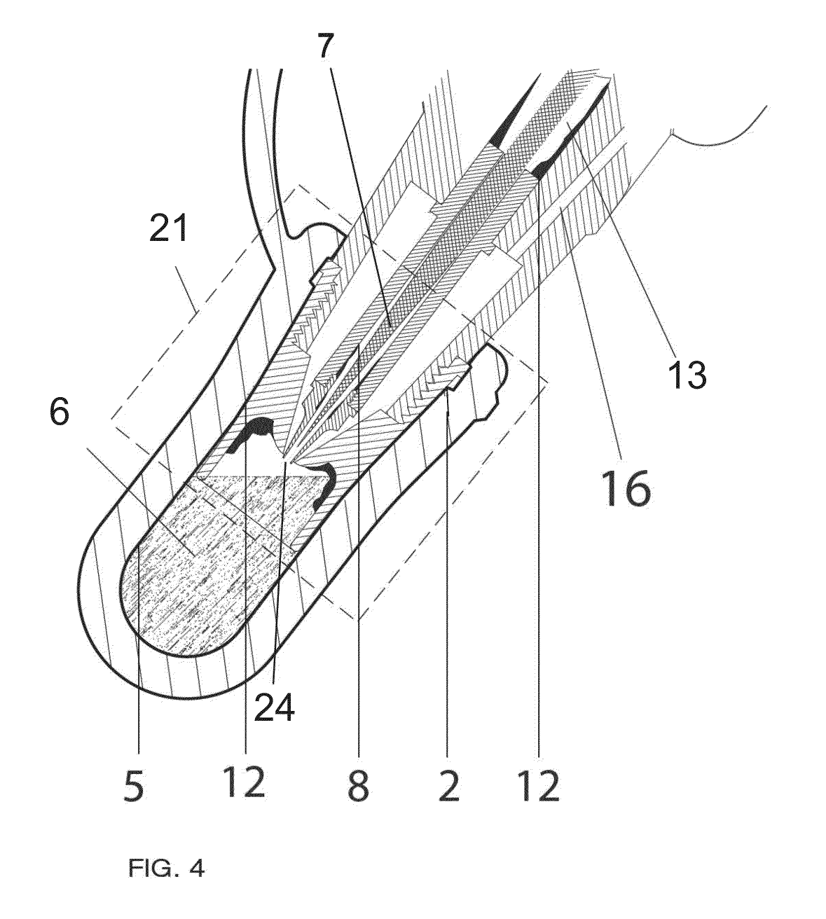

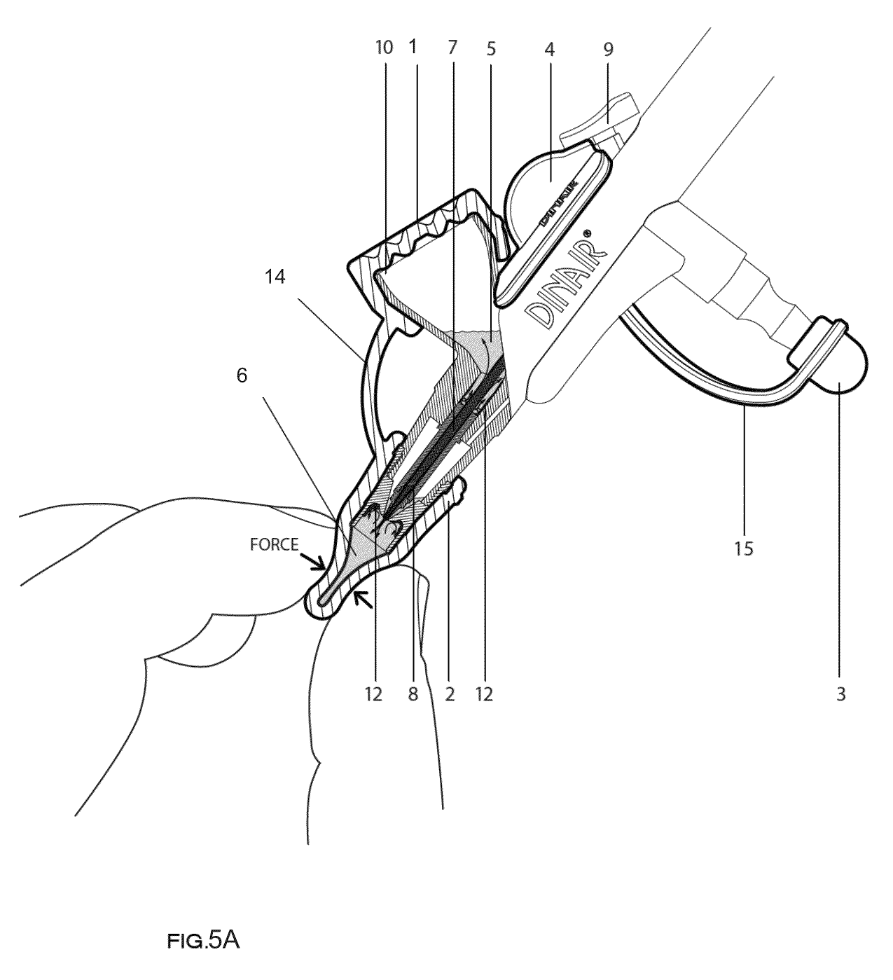

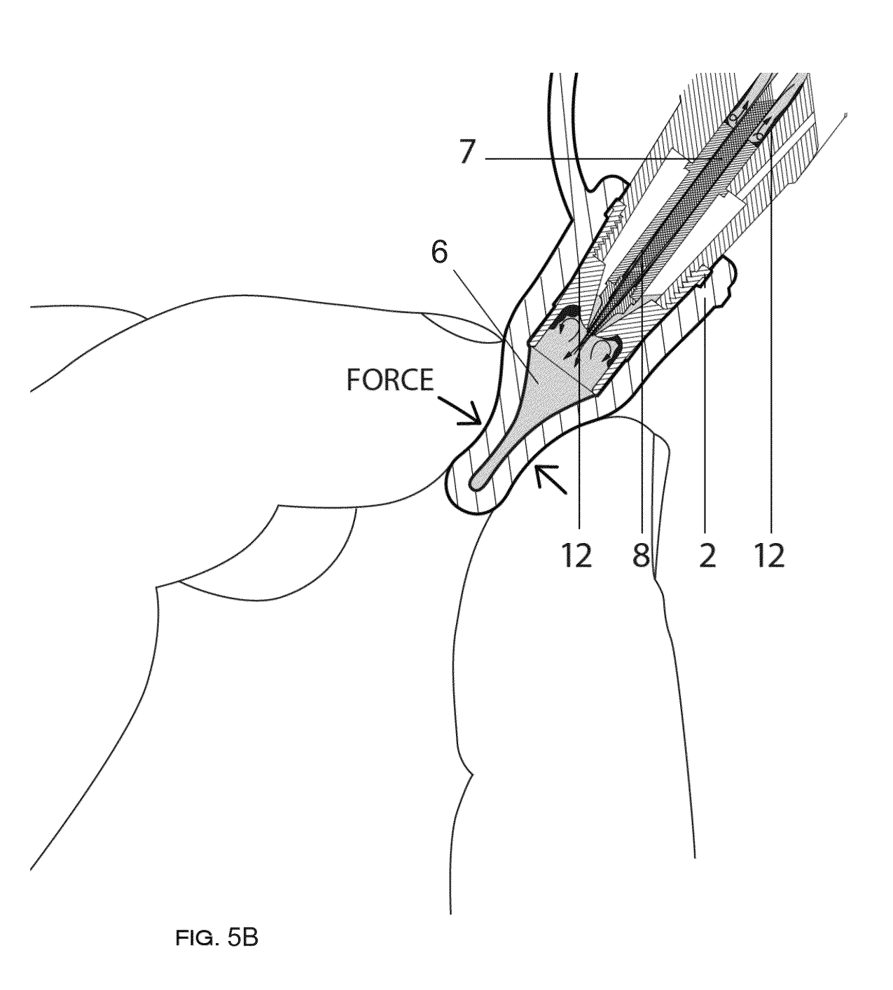

FIG. 4 is a close-up view of the airbrush tip. In the figure, there is a needle 7, the tip of which is in the needle assembly 21. The needle 7 is moved back and forth in the passageway 8, 13 by actuation of the lever 9 (FIG. 5A). The black substance 12 is intended to show cosmetic buildup or cosmetic residue in an exterior area of nozzle assembly adjacent the nozzle 24 and in the passageway 13 in the interior of the needle valve assembly.

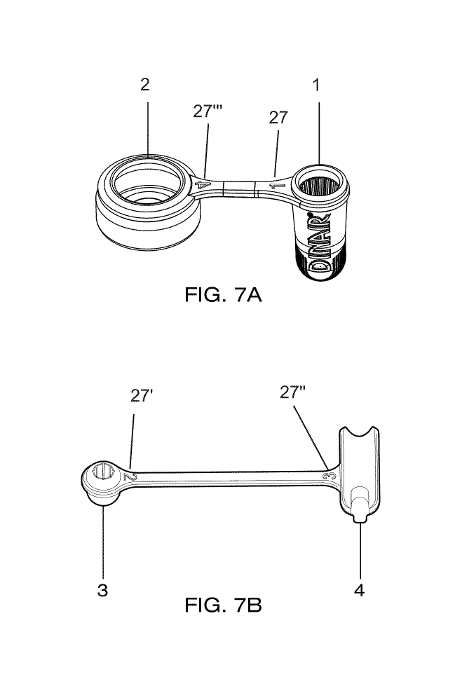

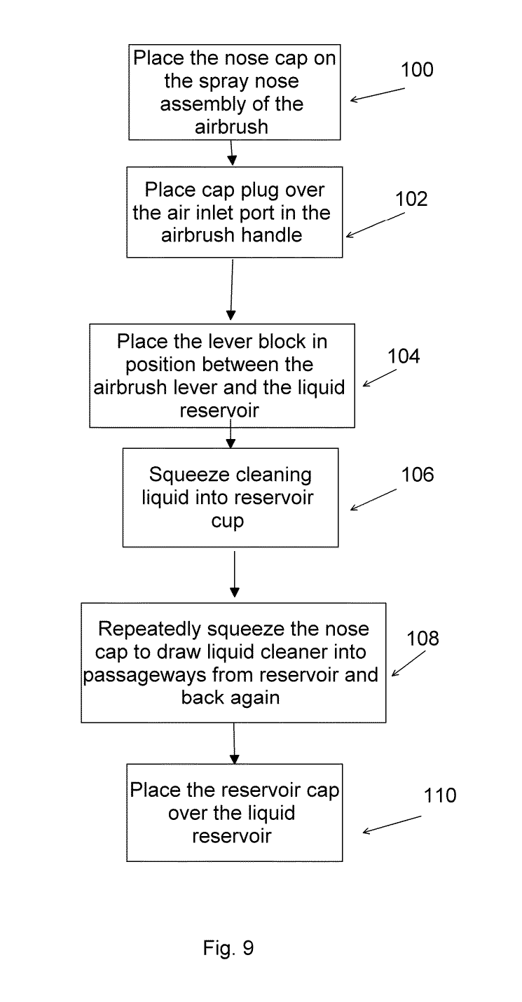

To clean the airbrush after it is used, the two component sets are positioned on the airbrush in a particular sequence that is shown in FIG. 7. A number sequence 1 through 4 (27, 27′, 27″, and 27′″) is integrally molded onto the tethers 14, 15 closest to the corresponding component for user reference. The method of using the cleaning system is shown in FIG. 9. First at step 100, the nose cap 2 is fit on the spray nose assembly 21 of the airbrush. The nose cap 2 has a deformable upper portion made of an elastic rubber type material and generally defines a solution chamber that contains the solution which, illustratively, is used to flush and clean dried and caked on makeup and other pigment residue from the airbrush nozzle and liquid passageway. The “solution” refers to the liquid 6 initially contained in the liquid reservoir cup 10 and subsequently moved to the open chamber 5 of the nose cap 2 by a compression squeezing action that is applied to the nose cap 2.

The next component to be put on the airbrush is the cap plug 3 that fits over the air inlet port 26 at the bottom of the handle 21 (FIG. 5) of the airbrush, at step 102. This is needed, because when the nose cap 2 is in place and squeezed, forcing cleaning solution 6 (FIG. 5) into the liquid passageway 8, it can also flow into the air passageway 16 (FIG. 4) as well. Thus, cleaning solution may leak out the air inlet port 26. The cap plug 3 is preferably made of an elastomeric material purposefully constructed to fit tightly over and create a seal onto the airbrush air inlet port 26 to prevent this event. The elastomeric material may be medical grade silicone.

The airbrush lever block 4 is the next component to be fit on the airbrush, which is positioned between the airbrush lever 9 and the liquid reservoir cup 10 to hold the airbrush needle in the ‘open’ position, at step 104. The normally closed position of the needle 7 is fully forward thus closing off the liquid passageway 8, 13. In order to direct the cleaning solution into the liquid passageway 8, 13, it is necessary to retract the needle 7 and open the liquid passageway 8 so that the passage between passageway 8 and passageway 13 is open. The lever block 4 is provided to be placed between the needle retractor lever 9 and the reservoir cup 10 thus holding the needle 7 in the fully open position creating an “open” passageway 13 between the bulb's open chamber 5 and the -reservoir cup 10.

The next step, step 106, is to squeeze an amount of airbrush cleaning liquid 6 into the liquid reservoir cup 10. The amount depends on the type of cleaner used and the size of the liquid reservoir cup 10, and may be for example three or four drops of liquid.

The airway passage 16 is open and cleaning solution may be pushed through this passage as well, when the nose cap 1 is pinched. The nose cap 1 should be repeatedly pinched to draw the cleaning liquid from the reservoir 10 through the liquid passageway 8 into the needle 7 and back again, through both the liquid passageway 8, at step 108. In this manner, all internal areas of the airbrush can be cleaned. The plug cap 3 is provided to cap the air inlet port 26 to prevent solution from leaking out the air inlet port 26.

The last component to be fitted on the airbrush is the reservoir cap 2, which is snapped over the liquid reservoir 10, at step 110. The reservoir cap 2 has a deformable bellows upper portion 26 that allows for the expansion and contraction of air pressure within the reservoir cup 10 when the nose cap 1 is squeezed. Furthermore, it is desired that the reservoir cap 2 remains in place on the liquid reservoir cup 10 to prevent spillage of cleaning solution if the airbrush is placed in any position. It is also desirable to retain cleaning solution 6 within the airbrush for an extended period of time to allow makeup residue to dissolve in the cleaner. For these purposes, the nose cap 1 and reservoir cap 2 are sized and constructed to fit securely over and create a seal onto the airbrush spray nose assembly 21 and liquid reservoir cup 10. The tether 14 between the nose cap 1 and the reservoir cap 2 provides tension to keep each component in place during use and also transportation. The cleaning system can be left in place when the airbrush is not being used, and because of the tight fit of the components on the corresponding parts of the airbrush, the liquid will not leak out.

Although the cleaning system has been shown and described herein as having a unitary, one piece construction, it is contemplated that the various caps and plugs can be provided as separate elements, or as elements that are removably connected to one another.

The cleaning system described herein is described with respect to an airbrush for applying makeup. However, the system and methods according to the disclosure apply equally well to an spray brush device, such as for spraying paint, glue, etc., where the sprayed liquid can dry and leave residue in the airbrush that needs to be cleaned out for proper function of the airbrush.

Although various features of the invention have been described with particular embodiments. It is considered within one of ordinary skill in the art to mix and match the features in other embodiments not depicted in the figures.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. An airbrush cleaning system comprising:
a nose cap configured to sealingly fit on a spray nose assembly of an airbrush;
a reservoir cap configured to sealingly fit over a liquid reservoir of the airbrush;
a first tether connecting the nose cap and the reservoir cap;
a cap plug configured to seal off an air inlet port of the airbrush;
a lever block configured to hold an airbrush needle in the open position; and
a second tether connecting the cap plug and the lever block.

2. The airbrush cleaning system of claim 1, wherein the nose cap, the reservoir cap and the first tether form a unitary, one piece component set.

3. The airbrush cleaning system of claim 1, wherein the cap plug, the lever block and the second tether form a unitary, one piece component set.

4. The airbrush cleaning system of claim 1, wherein the nose cap, the reservoir cap, the first tether, the cap plug, the lever block, and the second tether are made of a pliable, elastic material.

5. The airbrush cleaning system of claim 4, wherein the pliable elastic material is a medical grade silicone.

6. The airbrush cleaning system of claim 1, wherein the nose cap comprises an outer surface, an opening and an interior fluid storage region that fits circumferentially and seals onto the spray nose assembly of the airbrush to make an air tight seal.

7. The airbrush cleaning system of claim 6, wherein the outer surface of the nose cap is deformable such that when compressed and released causes any liquid inside the liquid reservoir to transfer between the fluid storage region through a liquid passageway in the spray nose assembly and the liquid reservoir and back again.

8. The airbrush cleaning system of claim 1, wherein the reservoir cap comprises an annular ring and a bellows portion covering the annular ring.

9. A kit comprising:
an airbrush for applying a liquid to a surface, the airbrush comprising a spray nose assembly through which the liquid is sprayed, a handle comprising an air inlet port; a reservoir into which the liquid is placed; a needle disposed in the spray nose assembly for controlling flow of the liquid; and an internal passageway between the spray nose assembly and the reservoir; and
cleaning components comprising:
a first component set comprising a nose cap configured to fit on the spray nose assembly, and a reservoir cap connected to the nose cap and configured to fit on the reservoir; and
a second component set comprising a cap plug configured to seal off the air inlet port of the airbrush, and a lever block connected to the cap plug and configured to hold the needle in the open position.

10. The kit of claim 9, further comprising a first tether connecting the nose cap and the reservoir cap, and a second tether connecting the cap plug and the lever block, wherein the first tether and the second tether provide tension between the nose cap and the reservoir cap, and between the cap plug and the lever block, respectively, to keep the first and second component sets in a desired sealed position when in use and during transportation.

11. The kit of claim 9, wherein the first component set comprises a pliable elastomeric material.

12. A method of cleaning the airbrush in the kit of claim 9, comprising:
placing the nose cap on the spray nose of the airbrush;
placing the cap plug over the air inlet port in the handle of the airbrush;
placing the lever block in position between the airbrush lever and the liquid reservoir;
squeezing an amount of cleaning solution into a liquid reservoir;
repeatedly squeezing the nose cap to draw the cleaning solution into the an internal passageway of the airbrush from the liquid reservoir and back again; and
placing the reservoir cap over the liquid reservoir.

13. A method of cleaning an airbrush, comprising:
placing a nose cap on a spray nose of the airbrush;
placing a cap plug over an air inlet port in a handle of the airbrush;
placing a lever block in position between an airbrush lever and the liquid reservoir;
squeezing an amount of cleaning solution into a liquid reservoir;
repeatedly squeezing the nose cap to flush the cleaning solution into an internal passageway of the airbrush from the liquid reservoir and back again; and
placing a reservoir cap over the liquid reservoir;
